(19) United States
(12) Patent Application Publication
(10) Pub. No.: US 2009/0155022 A1
(43) Pub. Date: Jun. 18, 2009

(54) Device for feeding book blocks

(76) Inventors: Jurgen Garlichs, Rahden (DE); Dirk Rygol, Rahden (DE); Holger Muller-Lorenschat, Rahden (DE); Christian Schmale, Lubbecke (DE)

Correspondence Address: ALIX YALE & RISTAS LLP, 750 MAIN STREET, SUITE 1400, HARTFORD, CT, 06103, US

(21) Appl. No.: 12/316,074

(22) Filed: Dec. 9, 2008

(30) Foreign Application Priority Data
Dec. 15, 2007 (DE) DE102007060569.4

(51) Int. Cl. B42C 19/08; B42C 11/02

(52) U.S. Cl. 412/21; 271/264

(57) ABSTRACT

A perfect-binding machine (1.1, 1.2), has a main transport system (11.1, 11.2) with revolving clamps (12, 13) and a feeder (21.1, 21.2) including a transporter (22) with pushers (25), a support (26) for the upright book blocks (2) in the spine region, and lateral guides (27). The drive (28) for the transporter is controlled in accordance with the position of the clamps such that an assigned pusher (25) moves aligned in a defined position relative to the corresponding clamp immediately before and/or during the closing of this clamp (12, 13). The book blocks (2) are fed to the respective clamps in an aligned fashion such that the transfer and the alignment of the book blocks on book stop catches on the clamps can be eliminated. Book blocks (2) can be fed to the book block clamps (12, 13) in such a way that they are clamped centrally (M).

### BACKGROUND

The present invention pertains to a device for feeding book blocks into the book block transport system of a perfect-binding machine.

DE 198 46 525 A1 shows and describes a perfect-binding machine with a book block transport system consisting of a plurality of book block clamps that can be continuously moved along a closed loop and are connected to one another in a driving fashion within identical distances from one another in order to clamp the book blocks arriving in the form of sheet stacks, with an infeed and a delivery and with a number of processing stations along linear transport sections.

DE 34 42 560 C2 and DE 34 45 928 C2 describe a feeding device for a book block transport system consisting of an endless transport chain that is driven in a revolving fashion and features pusher bars that push the book blocks forward, of a support for supporting the upright book blocks in the spine region and of lateral guides. The drive of the transport chain is mechanically coupled to the drive of the book block transport system. The book blocks are either fed to the book block clamps from obliquely below or on the same level in case of swing-type book block clamps. With respect to the subsequent processing in the perfect-binding machine, the book blocks need to be accommodated in the book block clamps in a precisely positioned fashion.

In order to compensate inaccuracies in the synchronicity between the book block clamps of the book block transport system and the pusher bars of the feeding device due to uneven chain elongations and play in the drive elements, the book block clamps respectively feature a book stop catch. The arriving book block is received from the pusher bar and aligned relative to the book block clamp by the book stop catch on the inner clamping jaw of the book block clamp that moves behind the book block during the turning movement of the book block clamp and passes the pusher bar during its subsequent transport movement. The book block is then laterally clamped by closing the book block clamp.

In this case, it is disadvantageous that he pivoting movement of the book stop catch into the stream of successively arriving book blocks requires a corresponding transport gap such that the maximum format height is limited with respect to the spacing of the book block transport system. Due to the rigid arrangement of the book stop catches in the book block clamps, the book blocks need to be positioned in the book block clamps with a fixed rear edge. The resulting eccentric accommodation of the book blocks in the book block clamps requires a high constructive expenditure with respect to the guidance of the outer clamping jaw and the force acting thereupon.

### SUMMARY

The object of the present invention is to provide a device for feeding a book block into the book block clamps in a precisely positioned fashion.

According to the present disclosure, this object is attained in that the transport means features a drive that can be controlled in accordance with the position of the book block clamps such that an assigned pusher bar moves aligned in a defined position relative to the corresponding book block clamp immediately before and/or during the closing of this book block clamp. Spacing tolerances and other inaccuracies of the book block transport system and of the transport means for feeding the book blocks are compensated by the drive control of the transport means. The book blocks are fed to the respective book block clamps in an aligned fashion such that the transfer and alignment of the book blocks by means of book stop catches is no longer required. The book stop catches on the book block clamps can be eliminated. The above-described limitations caused by the book stop catches are eliminated and a significantly broader format spectrum can be processed with the same clamp spacing of the book block transport system. In addition, the book block transport system can be shortened by the length of the transfer and alignment section.

Since the clamping process is time-related due to the elastic book block, it is advantageous that the respective pusher bar moves synchronous with the book block clamp at least during the closing thereof. The respective pusher bar may move with a faster or slower speed than the corresponding book block clamp before the closing thereof, e.g., in order to compensate a spacing of the pusher bars in the transport means that deviates from the clamp spacing. The respective pusher bar may move slower than the corresponding book block clamp after the closing thereof such that the pusher bar moves away from the clamped book block. The spacing between the pusher bars preferably is identical to the clamp spacing of the book block transport system.

The transport means can be controlled or variably controlled in accordance with a defined position of the book blocks in the book block clamps. The book block therefore can be clamped in the book block clamp at any location. The book blocks are preferably fed into the book block clamps and subsequently clamped centrally with respect to their format height that extends in the feeding direction such that the book block clamps are subjected to a symmetric stress that allows a significantly simpler constructive design of the book block clamps with respect to the guidance of the movable outer clamping jaw and the force acting thereupon.

### BRIEF DESCRIPTION OF THE DRAWING

Characteristics of the present invention are described below with reference to preferred embodiments that are illustrated in the enclosed drawing, in which:

FIG. 1 shows a simplified perspective representation of a perfect-binding machine with an inventive feeding device;

FIG. 2 shows an identical perspective representation of a perfect-binding machine with swing-type book block clamps and an inventive feeding device, and

FIGS. 3a, b respectively show a front view of the book block clamps with a book block accommodated therein.

### DETAILED DESCRIPTION

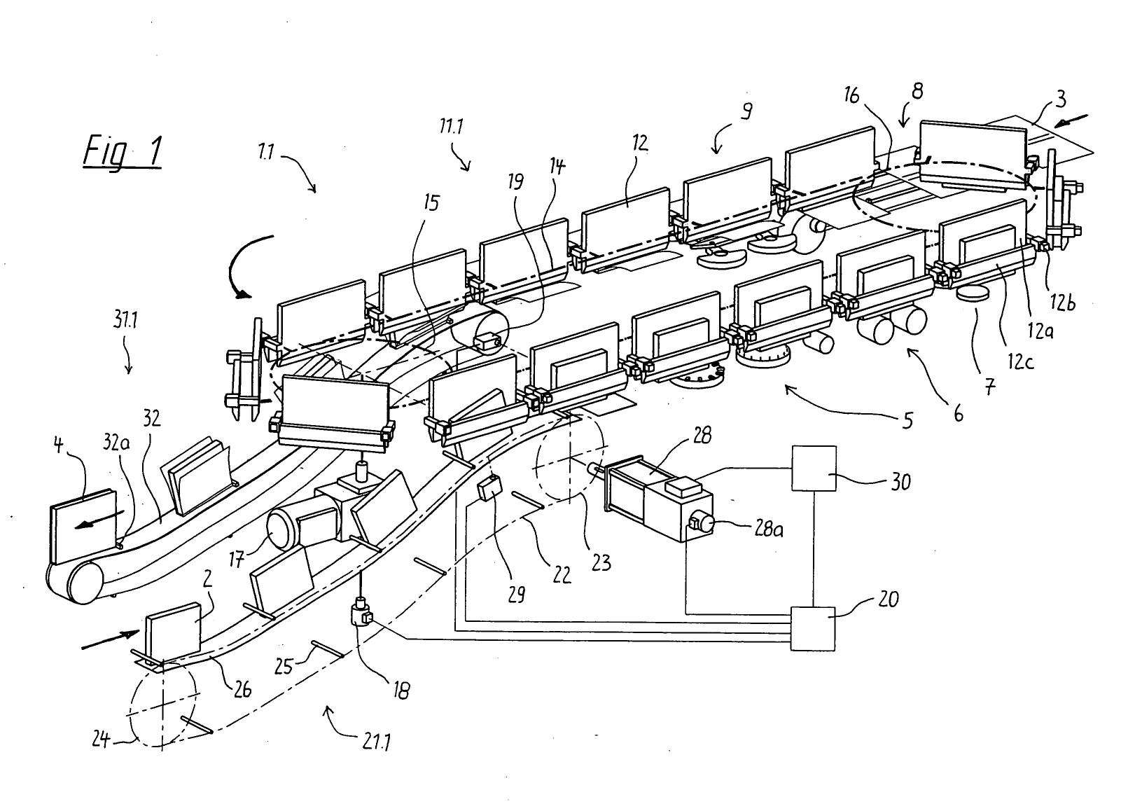

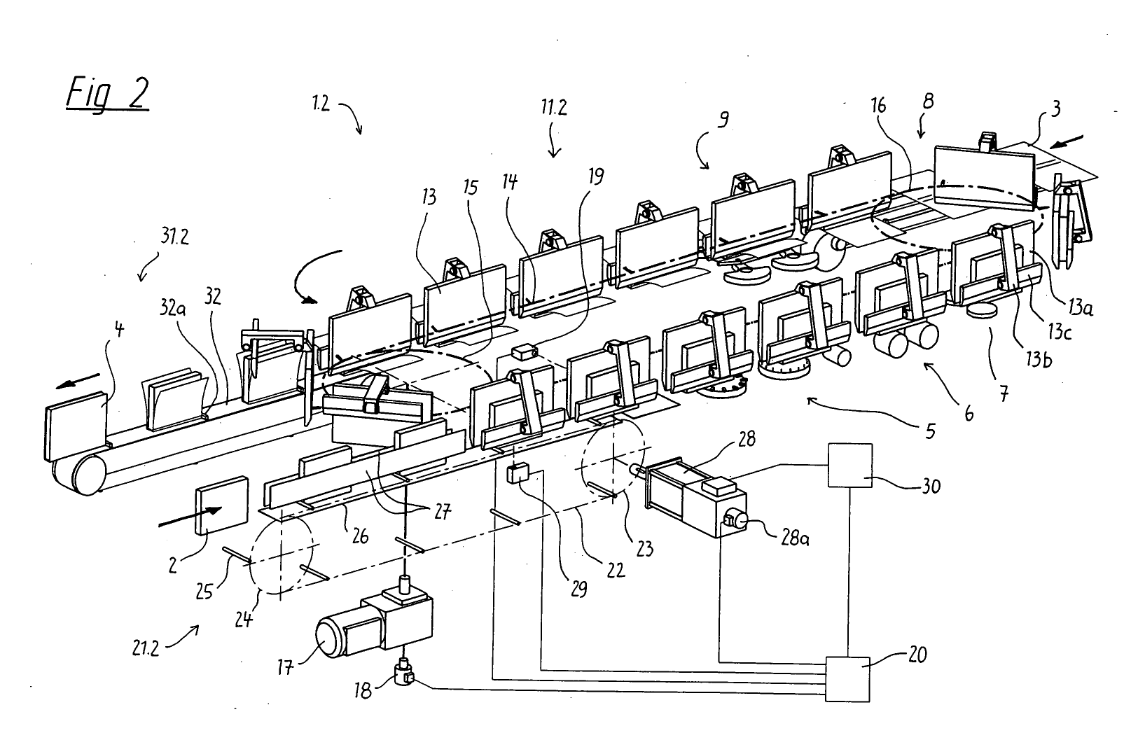

FIGS. 1 and 2 respectively show perfect-binding machines 1.1 and 1.2 that consist of book block transport systems 11.1 and 11.2 with a plurality of respective book block clamps 12 and 13 that can be continuously moved along a closed oval loop and are coupled in a driving fashion to a transport chain 14 within identical distances from one another, with respective feeding devices 21.1 and 21.2 for feeding the book blocks 2 gathered of folded sheets to the book block clamps 12 and 13, and with respective deliveries 31.1 and 31.2 for delivering the perfect-bound brochures 4 or book blocks. The transport chain 14 revolves around a driving wheel 15 that is driven by a gear motor 17 and a deflection pulley 16 in accordance with the oval loop.

Devices for the spine processing 5, the glue application on the spine 6 and the glue application 7 on the sides of the book blocks 2 are arranged along a first linear transport section of the respective book block transport systems 11.1 and 11.2. A cover feeder 8 and at least one cover pressing device 9 for pressing a cover 3 against the spine of the book block 2 with the glue applied thereon are arranged along a second linear transport section.

The perfect-binding machines 1.1 and 1.2 differ with respect to their respective book block clamps 12 and 13. The perfect-binding machine 1.1 according to FIG. 1 comprises a book block transport system 11.1 with book block clamps 12 that feature an inner stationary clamping jaw 12a and an outer clamping jaw 12c that can be displaced perpendicular to the inner clamping jaw 12.1 by means of slideways 12b. The book block transport system 11.2 of the perfect-binding machine 1.2 shown in FIG. 2 is provided with swing-type book block clamps 13, in which an outer clamping jaw 13c can be moved relative to the stationary inner clamping jaw 13a by means of a swing arm 13b, wherein the outer clamping jaw 13c is always guided parallel to the inner clamping jaw 13a. In the region of the deflection around the driving wheel 15, the respective outer clamping jaws 12c and 13c are actuated by not-shown opening and closing cams, wherein the respective book block clamps 12 and 13 generate a defined clamping force between the respective clamping jaws 12a, 12c and 13a, 13c.

The respective feeding devices 21.1 and 21.2 comprise an endless transport chain 22 that revolves around the driving wheel 23 and a deflection pulley 24 and is provided with pusher bars 25 that push the book blocks 2 forward, a support 26 for supporting the upright book blocks 2 in the spine region, and lateral guides 27.

The feeding device 21.1 feeds the book blocks 2 to the book block clamps 12 that are opened only slightly greater than the product thickness, from obliquely below. The book block clamps 13 of the feeding device 21.2, in contrast, swing open relatively far and therefore allow a linear feed on the same level. The transport paths of the feeding devices 21.1 and 21.2 that are designed to that effect are shown in FIGS. 1 and 2.

The perfect-bound brochures 4 are downwardly guided out of the book block clamps 12 in the delivery 31.1 of the book block transport system 11.1 and transferred to a conveyor belt 32 with pusher bars 32 a bonded thereon, wherein the brochures 4 are laterally guided by not-shown guides. Such a conveyor belt 32 with pusher bars 32a is also provided in the delivery 31.2 of the book block transport system 11.2, but this conveyor belt has a linear design and is arranged on almost the same level as the book block transport system 11.2.

According to an aspect of the invention, the transport chain 14 of the respective feeding devices 11.1 and 11.2 features a servomotor 28 that can be controlled in accordance with the position of a book block clamp 12 or 13 such that an assigned pusher bar 25 moves aligned in a defined position relative to the respective book block clamp 12 or 13 in association with (e.g., immediately before and/or during) the closing of this book block clamp 12 or 13.

For this purpose, the motor control 30 of the servomotor 28 is connected to a master control 20, in which the actual position of the respective book block clamp 12 or 13 is calculated in accordance with the signal of a shaft encoder 18 arranged on the driving wheel 15 of the respective book block transport system 11.1 or 11.2, wherein the position is calculated based on a reference position that is set immediately prior thereto by a light barrier 19 that reacts to a reference edge of the respective book block clamps 12 and 13. The shaft encoder 18 and the light barrier 19 therefore form a measuring system for determining the position of the respective book block clamps 12 and 13. This referencing is carried out for each book block clamp 12 or 13 in order to detect possible deviations in the spacing between the individual book block clamps 12 and 13.

A light barrier 29 is provided for the same reason in the respective feeding devices 21.1 and 21.2 in addition to the resolver feedback 28a of the servomotor 28, wherein this light barrier quasi references the respectively assigned pusher bar 25. The resolver feedback 28a and the light barrier 29 form the measuring system for determining the position of the respective pusher bars 25.

The transport chain 22 is driven in a controlled fashion by the servodrive 28 such that a book block 2 pushed forward by the pusher bar 25 is arranged in a predefined position relative to the continuously moving book block clamps 12 and 13. The transfer and the alignment of the book blocks 2 by means of books stop catches on the respective book block clamps 12 and 13 are no longer required, which is why the book block clamps 12 and 13 illustrated in the figures no longer feature such books top catches. The pusher bar 25 can be moved underneath the respective clamping jaws 12a, 12b and 13a, 13b wherein it momentarily remains in contact with the head of the book block, in the region of its overhang from the book block clamp.

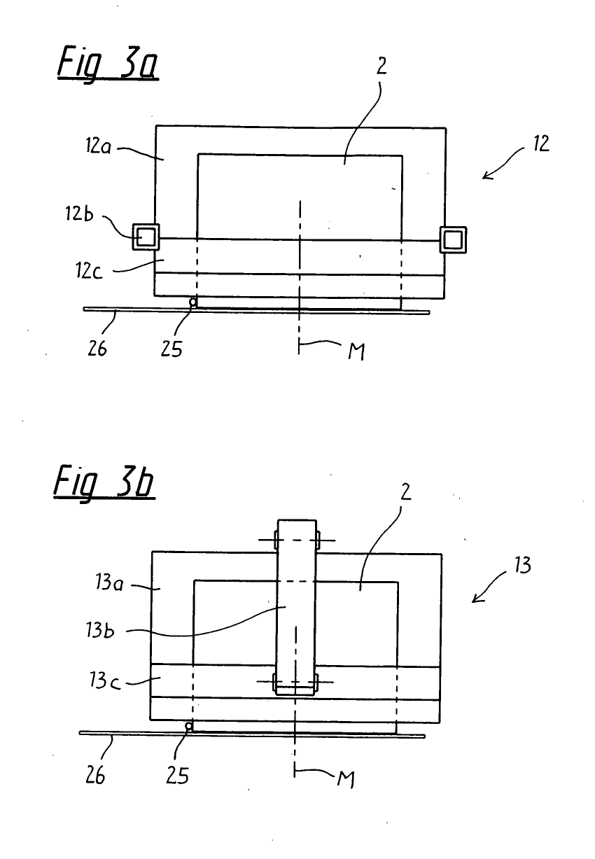

The inventive feeding devices 21.1 and 21.2 make it possible to clamp the book blocks 2 in the book block clamps 12 and 13 arbitrarily and, in particular, centrally as indicated in FIGS. 3a and 3b with the common center line M of the respective book block clamps 12 and 13 and the book block 2. The resulting symmetric stress of the book block clamps 12 and 13 allows a significantly simpler constructive design of the book block clamps 12 and 13 with respect to the guidance of the respective outer movable clamping jaws 12c and 13c and the force acting thereupon.

The respective pusher bar 25 may move with a faster or slower speed than the corresponding book block clamp 12 or 13 before the closing of the book block clamp 12 or 13, e.g., in order to compensate a spacing of the pusher bars 25 that deviates from the clamp spacing in the respective feeding devices 21.1 and 21.2. In both embodiments, the spacing of the pusher bars 25 is identical to the clamp spacing of the respective book block transport systems 11.1 and 11.2. After the clamping of the book block 2, the respective pusher bar 25 may move slower than the corresponding book block clamp 12 or 13 such that the pusher bar 25 moves away from the clamped book block 2. Since the clamping process is a time-related process due to the elastic book block 2, the respective pusher bar 25 moves synchronous with the respective book block clamp 12 or 13 for at least this duration.

In the embodiments, the inventive feeding devices 21.1 and 21.2 feature a drive that is realized separately of the drive of the respective book block transport systems 11.1 and 11.2. However, an inventive feeding device can also be realized in such a way that the drive of the transport chain 22 comprises an overriding drive with a mechanical drive connection for driving the book block transport system on the first input and a driving element that can be controlled by a control device on the second input.

1. A device for feeding book blocks (2) into a book block transport system (11.1, 11.2) of a perfect-binding machine (1.1, 1.2), comprising:
a book block transport system (11.1, 11.2) including a plurality of open and closable book block clamps (12, 13) that are connected to one another in spaced relation and are movable continuously with a common drive (17) along a closed loop in a forward direction through a book block receiving location where each open clamp is closed;
a feeding device (21.1, 21.2) including a driven (28) transporter (22) with pusher bars (25) that push upright book blocks (2) forward to said receiving location, a spine support (26) for the pushed book blocks (2), and lateral guides (27);
wherein the transporter drive (28) is controlled by a control device (20) in dependence on a position of each book block clamp (12, 13) such that each pusher bar (25) moves to a defined position relative to the corresponding book block clamp (12, 13) in association with the closing of this book block clamp (12, 13) at said receiving location.

2. The device according to claim 1, wherein the transporter (22) is controlled such that each pusher bar (25) moves synchronous with the corresponding book block clamp (12, 13) at least during the closing.

3. The device according to claim 1 wherein the transporter (22) is controlled such that each pusher bar (25) moves with a faster or slower speed than the corresponding book block clamp (12, 13) prior to the closing of the book block clamp (12, 13).

4. The device according to claim 1 wherein the transporter (22) is controlled such that each pusher bar (25) moves slower than the corresponding book block clamp (12, 13) after the closing of the book block clamp (12, 13).

5. The device according to claim 1 wherein the transporter (22) has a pitch defined by mutual spacing between the pusher bars (25) and said pitch is identical to the clamp spacing of the book block transport system (11.2, 11.2).

6. The device according to claim 1, wherein the transporter (22) is controlled in dependence on a defined position of the book blocks (2) in the book block clamps (12, 13).

7. The device according to claim 6, wherein the book blocks have a format height that extends in the forward direction and the book blocks (2) are fed to and clamped in the book block clamps (12, 13) centrally (M) within said format height.

8. The device according to claim 1 wherein the drive (28) of the transporter (22) is separate from the drive (17) of the book block transport system (11.1, 11.2).

9. The device according to claim 1 wherein the drive of the transporter (22) comprises an overriding drive with a mechanical drive connection for driving the book block transport system (11.1, 11.2) on a first input and a driving element that can be controlled by a control device on a second input.

10. The device according to claim 8 wherein the control device (20) is connected to the drive (17) of the book block transport system (11.1, 11.2).

11. The device according to claim 8 wherein the control device (20) features a measuring system (18, 19) for determining the position of the corresponding book block clamp (12, 13).

12. The device according to claim 8 wherein the control device (20) features a measuring system (28a, 29) for determining the position of the corresponding pusher bar (25).

13. The device according to claim 1, wherein said association with the closing of the book block clamp provides that each pusher bar (25) moves to a defined position immediately before said closing.

14. The device according to claim 1, wherein said association with the closing of the book block clamp provides that each pusher bar (25) moves to a defined position during said closing.

15. The device of according to claim 2, wherein the transporter (22) is controlled in dependence on a defined position of the book blocks (2) in the book block clamps (12, 13).

16. The device according to claim 15, wherein the book blocks have a format height that extends in the forward direction and the book blocks (2) are fed to and clamped in the book block clamps (12, 13) centrally (M) within said format height.

17. The device according to claim 1 wherein the control device (20) is responsive to at least one measurement signal (18, 19) indicative of the position of each book bock clamp along said closed loop as it approaches said receiving location and to at least one measurement signal (28a, 29) indicative of the position of each pusher bar (25) as it approaches said receiving location.

18. The device according to claim 2 wherein the control device (20) is responsive to at least one measurement signal (18, 19) indicative of the position of each book bock clamp along said closed loop as it approaches said receiving location and to at least one measurement signal (28a, 29) indicative of the position of each pusher bar (25) as it approaches said receiving location.
